(19) United States
(12) Patent Application Publication
(10) Pub. No.: US 2008/0210092 A1
(43) Pub. Date: Sep. 4, 2008

(54) METHODS AND APPARATUS FOR REMOVING ACID GASES FROM A NATURAL GAS STREAM

(75) Inventors: John J. Buckles, The Woodlands, TX (US); Anthony P. Eaton, Nedlands (AU); Kaman I. Chan, Houston, TX (US)

Correspondence Address: CHEVRON CORPORATION, P.O. BOX 6006, SAN RAMON, CA, 94583-0806, US

(73) Assignee: CHEVRON U.S.A. INC., San Ramon, CA (US)

(21) Appl. No.: 12/024,273

(22) Filed: Feb. 1, 2008

Related U.S. Application Data
(60) Provisional application No. 60/899,285, filed on Feb. 2, 2007.

(51) Int. Cl. B01D 53/14

(52) U.S. Cl. 95/204; 95/232; 96/242; 95/227

(57) ABSTRACT

Method and apparatus for separating acid gas from a natural gas stream. The method includes the steps of: contacting the natural gas stream with a semi-lean amine solution and a lean amine solution to produce a rich amine solution, separating a first portion of carbon dioxide from the rich amine solution to produce the semi-lean amine solution, and heating a portion of the semi-lean amine solution to separate a second portion of carbon dioxide and produce the lean amine solution. The rich amine solution and semi-lean amine solution are heated from using recovered waste heat derived from one or more of a land based facility or an off-shore facility located on a platform or floating vessel.

### FIELD OF THE INVENTION

The invention relates to the removal of acid gases from natural gas streams. More specifically, the invention relates to the removal of carbon dioxide, hydrogen sulfide and other potentially corrosive gases that are commonly found in natural gas produced from underground reservoirs. Acid gas removal units that employ amine solutions that first absorb and then can be regenerated are of particular interest.

### BACKGROUND OF THE INVENTION

A traditional, single-stage gas sweetening amine process offers flexibility and high carbon dioxide removal capability needed for natural gas liquefaction facilities. However, it is relatively heat-intensive due to its amine regeneration step and usually requires installation of fired heaters to supply the large heat demand. Fired heaters present a high risk ignition source and are not favorable for use in conjunction with LNG facilities either on shore or off shore, such as on a platform or floating vessel. To eliminate this safety hazard and to reduce the generation of carbon dioxide, NOx and SOx, an amine treating system is presented here which is designed with sufficiently low heat requirements to enable operation on recovered waste heat, eliminating the need for fired heaters. The target application of this process is for floating LNG applications where the produced natural gas has a relative high carbon dioxide content such as in locations typical of Southeast Asia.

The amine treating application chosen for this application is a two-stage absorber process consisting of a semi-lean and a lean amine loops. This configuration is able to reduce the regeneration heat requirement by as much as 60% by splitting the rich amine flow into two closed amine regeneration loops, and thus allowing the unit to operate totally on the waste heat recovery system. A comparison of the performance between a baseline single-stage absorber process and a two-stage absorber process is included. Simulations were used to map out the feasible range of allowable acid gas concentrations, circulation rates, and regeneration heat requirements that are operable without depending on onboard fired heater.

### SUMMARY OF THE INVENTION

In one embodiment the invention provides a method for separating acid gas from a natural gas stream. The method includes the steps of contacting the natural gas stream with a semi-lean amine solution and a lean amine solution to produce a rich amine solution, separating a first portion of carbon dioxide from the rich amine solution to produce the semi-lean amine solution, heating a portion of the semi-lean amine solution to separate a second portion of carbon dioxide and produce the lean amine solution, and wherein the rich amine solution and semi-lean amine solution are heated from using recovered waste heat.

The waste heat can be recovered from one or more of a land based facility or an off-shore facility located on a platform or floating vessel. More specifically, the waste heat can be recovered from one or more of a turbine, compressor, and compressor driver. The first portion of carbon dioxide can be separated from the rich amine solution by one or more of reducing the pressure on the rich amine solution and heating the rich amine solution. Where the rich amine solution is heated, the heat can be provided to the rich amine solution in a flash vessel from an overhead stream of a stripper column, the stripper column having a reboiler heated with the recovered waste heat. Similarly, the semi-lean amine solution can be heated in a stripper column. Heat can be provided to the stripper column through a reboiler heated with the recovered waste heat.

The method is particularly useful for removing carbon dioxide from streams having a relatively high concentration of carbon dioxide such as where the natural gas stream contains at least about 7 mol % carbon dioxide, in some cases at least 7.5 mol % carbon dioxide, and in still others, at least about 8 mol % carbon dioxide.

Optionally, the rich amine solution can be flashed in a flash vessel to remove hydrocarbon vapor before separating the first portion of carbon dioxide from the rich amine solution.

In another embodiment, the invention provides a method for reducing emissions from an acid gas treating unit associated with a natural gas liquefaction plant. Such a method includes the steps of contacting a natural gas stream with a semi-lean amine solution and a lean amine solution to produce a rich amine solution, heating the rich amine solution to and produce the semi-lean amine solution, heating a portion of the semi-lean amine solution to separate carbon dioxide and produce the lean amine solution, and wherein the rich amine solution and semi-lean amine solution are heated with recovered waste heat.

In such an embodiment, the waste heat can be recovered from one or more of a land-based facility, or an off-shore facility located on a platform or floating vessel. The waste heat can also be recovered from a heat generating unit in a liquefaction plant, such as one or more of a turbine, compressor, and compressor driver. The rich amine solution and semi-lean amine solution can be heated without the use of a fired heater.

Optionally, the carbon dioxide separated from the rich amine solution and semi-lean amine solution can be sequestered such as for further processing or handling.

In another embodiment, the invention provides a method for operating an acid gas treating unit associated with a natural gas liquefaction plant. The method includes the steps of recovering heat from a liquefaction facility, regenerating in an acid gas treating unit a rich amine solution by heating the rich amine solution to separate carbon dioxide and produce a semi-lean amine solution, contacting a natural gas stream with the semi-lean amine solution to remove carbon dioxide from the natural gas stream and produce a rich amine solution, and wherein the rich amine solution is heated with heat recovered from the liquefaction facility such that no additional carbon dioxide is emitted from the liquefaction facility and the acid gas treating unit when regenerating the rich amine solution. Optionally, the method can further include the steps of heating a portion of the semi-lean amine solution with heat recovered from the liquefaction facility to separate carbon dioxide from the semi-lean solution to produce a lean amine solution, and contacting the natural gas stream with the lean amine solution to remove carbon dioxide from the natural gas stream and produce a rich amine solution. Optionally, the method can further include the sequestering the carbon dioxide separated from the rich amine solution.

The heat can be recovered from a liquefaction facility located on shore or on an off-shore facility located on a platform or floating vessel, such as from one or more of a turbine, compressor, and compressor driver in the liquefaction facility.

In yet another embodiment, the invention provides an apparatus for liquefying a natural gas stream. The apparatus includes a liquefaction unit having a heat generating unit and an acid gas treating unit connected to the liquefaction unit. The acid gas treating unit includes an amine absorber for contacting a natural gas stream with a semi-lean amine solution and a lean amine solution to remove carbon dioxide from a natural gas stream and produce a rich amine stream, a first flash vessel connected to the amine absorber for separating a first portion of carbon dioxide from the rich amine solution to produce the semi-lean amine solution, and a stripper column connected to the flash vessel for separating a second portion of carbon dioxide from a portion of the semi-lean amine solution to produce the lean amine solution. The stripper column is connected to the heat generating unit for receiving heat therefrom.

The apparatus can optionally include a second flash vessel connected intermediate the amine absorber and the first flash vessel, the second flash vessel for removing hydrocarbon vapors from the rich amine solution. One or more of the liquefaction unit and the acid gas treating unit can be located on shore, or off-shore on a platform or floating vessel and the heat generating unit can include one or more of turbine, compressor, and compressor driver. In some embodiments, the heat generating unit does not comprise a fired heater.

### BRIEF DESCRIPTION OF THE DRAWINGS

The invention may be understood by reference to the following description taken in conjunction with the accompanying drawings.

FIG. 1 is a schematic representation of an acid gas removal unit of the present invention.

FIG. 2 is a graph representing a simulated reboiler duty as a function of the carbon dioxide feed concentration.

FIG. 3 is a graph representing the amine circulation rate as a function of the carbon dioxide feed concentration.

FIG. 4 is a graph representing the amine circulation rate as a function of the reboiler duty.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

As used herein, “one or more of” and “at least one of” when used to preface several elements or classes of elements such as X, Y and Z or X₁-Xₙ, Y₁-Yₙ and Z₁-Zₙ, is intended to refer to a single element selected from X or Y or Z, a combination of elements selected from the same class (such as X₁ and X₂), as well as a combination of elements selected from two or more classes (such as Y₁ and Zₙ).

A two-stage absorber amine system is presented which is designed with sufficiently low heat requirements to enable operation on waste heat only. This allows elimination of fired heaters. The target application is for Floating LNG (FLNG) deployment in high CO₂ (up to 15 mole %) locations.

Although traditional single-stage processes offer flexibility and high CO₂ capability needed for this FLNG application, they are relatively heat-intensive due to their regeneration step. These processes would likely require more heat than is available from a Waste Heat Recovery Unit (WHRU). Moreover, because the use of fired heaters presents a high risk ignition source for floating environment, eliminating them would be highly desirable. A two-stage absorber design with a semi-lean amine loop offers the potential to reduce the heat demand substantially.

The heat load is reduced by having the majority of the regeneration done simply by pressure release at low pressure with the stripper overhead vapor as energy source. This semi-lean solvent is used for bulk acid gas removal. A small amount of the semi-lean solution is fed to the stripper to obtain very low CO₂ loading and is used as polishing agent to ensure tight gas specification can be met.

Comparison studies show that a two-stage process is beneficial for natural gas containing more than 7.5 mole % CO₂ by reducing the reboiler duty down to the WHRU limit. This process can be designed for very low energy demand with trade-off in large solvent circulation rate.

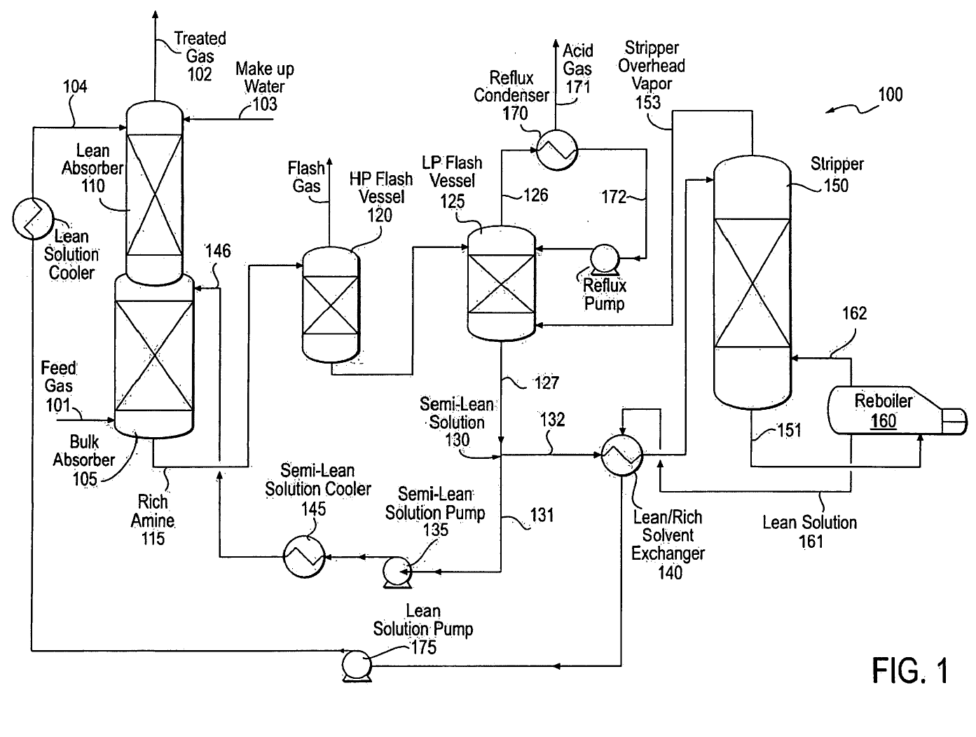

FIG. 1 shows the schematic of a two-stage absorber process. For this two-stage process design, the bulk solvent regeneration is achieved first by pressure reduction to a LP flash vessel with the stripper overhead vapor as the energy source. About 87 percent of the semi-lean solution leaving the bottom of this vessel will be recycled back to the lower section of the absorber (bulk absorber) for bulk acid gas removal.

The gas stream leaving the bulk absorber section typically contains approximately 3 to 4 mole % of CO₂ and requires further treating. The rest of the semi-lean solution not recycled back to the bulk absorber will be fed to the stripper for regeneration in order to achieve very low lean amine loading. After regeneration, the lean solution is then sent to the upper section of the absorber (lean absorber) as polishing agent to ensure that the natural gas specification can be met.

A low acid gas pressure is beneficial for solvent regeneration at the LP flash vessel because the lower this pressure is, the lower the CO₂ partial pressure can be obtained at the bottom of the vessel. This means that the semi-lean solution used for bulk acid gas removal will have sufficiently low CO₂ loading, so that allows more CO₂ to be absorbed per cubic meter of circulated solvent.

HP flash is included in this configuration to remove most of the dissolved and entrained gases from the amine solvent and to ensure that tight acid gas specification can be met. This is critical if the acid gas (CO₂) is subject for re-injection. The amount of high pressure flash gas is more than a traditional single-stage process because of the large solvent circulation rate. This HP flash gas can be used as fuel gas onboard of the FLNG.

The LNG production assumed for this comparison is 10 MMTPA with 2×50% parallel trains. Feed gas enters each train and is split between two parallel Acid Gas Removal Units (AGRUs) because of size limitations on fabrication of the absorber columns. A total of four AGRUs for 10 MMTPA LNG will be required. Feed gas CO₂ concentration ranges from 1 mole % up to 15 mole % were investigated to map out the operability of the two-stage process. Table 1 below summarizes the design conditions for each AGRU.

TABLE 1
AGRU Design Basis

| Feed Gas Temperature | 22° | C. |
|---|---|---|
| Feed Gas Pressure | 70 | bara |
| Capacity | Operating: 2.5 MMTPA | |
| | Design: 3 MMTPA | |
| CO₂ Feed Concentration | 1-15 | mole % |
| Acid Gas Pressure | 1.7 | bara |
| Treated Gas Specification | | |
| Carbon Dioxide | 50 | ppmv |
| Hydrogen Sulfide | 3 | ppmv |

| | |
|---|---|
| Solvent | Activated MEDA |

Table 2 summarizes the design basis for the waste heat recovery configuration. Waste heat is assumed to be recovered from four Frame 7 refrigerant compressor drivers to meet all the process thermal loads. Hot oil will be used as the heating medium. The total thermal demand for inlet gas processing, MEG regeneration, stabilization reboilers, fractionation reboilers, and fuel gas heating is approximately 152 MW. It is estimated that 118 MW of waste heat can be recovered from each Frame 7 turbine. The total waste heat available is 4×118 MW (472 MW), and the waste heat available for amine regeneration will be approximately 160 MW per LNG train.

TABLE 2
Waste Heat Recovery Design Basis

| | |
|---|---|
| Production Rate | 2 X 5 MMTPA |
| Waste Heat Recovery | 4 X Frame 7EA Turbines |
| Configuration | |
| Waste Heat Recovered per Turbine | 118 MW |
| Heating Medium | Hot Oil |
| Temperature | Supply: 280° C. |
| | Return: 150° C. |
| Process Thermal Load | |
| Estimation: | |
| Inlet Gas Processing | 35 MW |
| MEG Regeneration and | 85 MW |
| Stabilization | |
| Fractionation Reboilers | 22 MW |
| Fuel Gas Heating | 10 MW |

Single-Stage Process Vs. Two-Stage Process

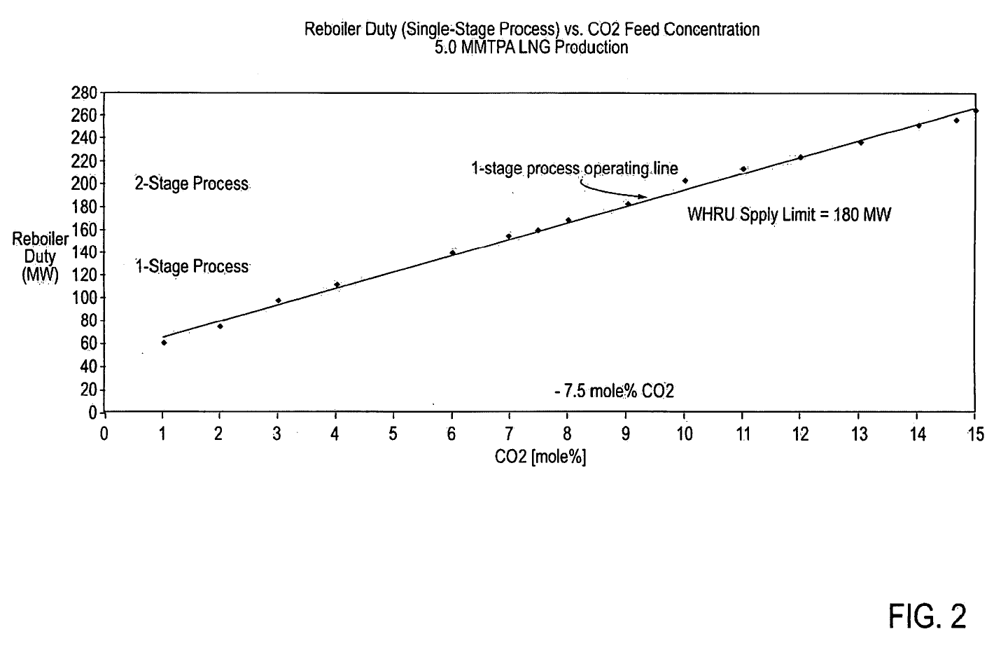

This section compares the traditional single-stage process and the proposed two-stage process with a semi-lean solvent loop for gas feeds containing CO₂ up to 15 mole %. The impact of CO₂ concentration can then be measured to show when two-stage process may be attractive. FIG. 2 shows the regeneration duty requirements for a single-stage process.

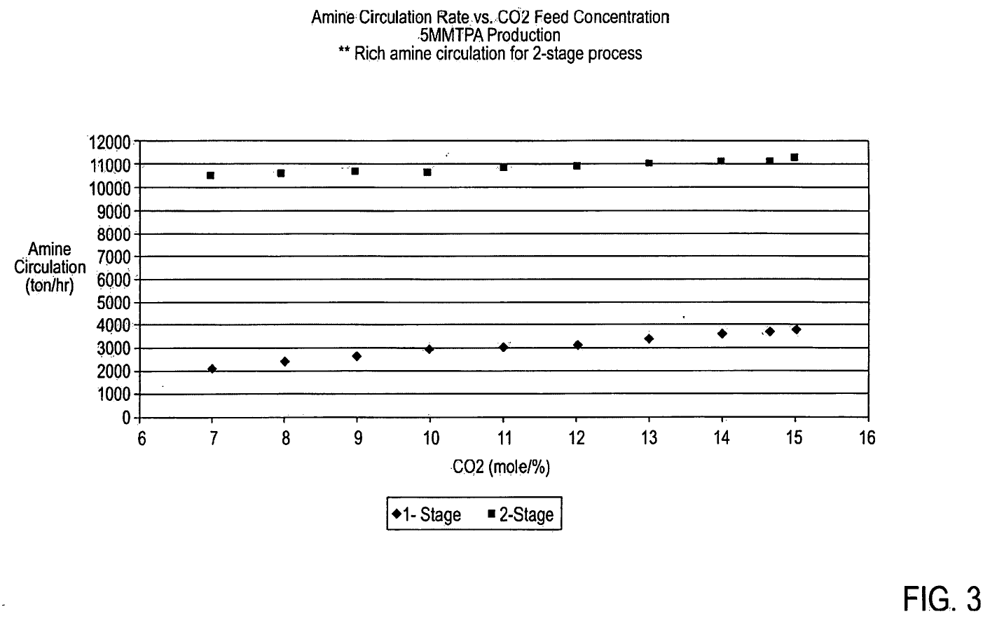

As expected, the energy required for solvent regeneration increases with the feed gas CO₂ concentration. This graph also shows the 160 MW waste heat limitation line. For feed gas with CO₂ concentrations less than approximately 7.5 mole %, a single-stage process is an adequate design for acid gas removal that totally dependent on waste heat recovery. However, as the concentration increases above 7.5 mole %, the regeneration heat demand exceeds the 160 MW limit, and thus fired heaters have to be installed for supplemental heating. In these cases, a two-stage process can be utilized to lower the heat demand down to the waste heat recovery limit by cutting the reboiler duty as much as 40%; however, these energy savings are sacrificed by the increasing solvent circulation rates as shown in FIG. 3. For the 2-stage process, the plotted amine circulation rates are the rich amine flows from the bottom of the bulk absorbers. The reboiler duty in each case is kept at 160 MW which is the total waste heat available for amine regeneration for one LNG train.

As shown from FIG. 3, the amine circulation rate for the two-stage process is three times the single-stage process at approximately 11,200 tons/hr for 15 mole % CO₂. The large increase in solvent demand is because the majority of the acid gas removal is done by semi-lean solution which has a much higher lean CO₂ loading than the lean solvent regenerated in a single-stage process. The ratio increases even to as much as 4.5 as the CO₂ concentration decrease to the 7.5 mole % cut off point. This shows that the two-stage process is much more beneficial to high CO₂ concentration feed gases. A high solvent circulation rate means larger equipment sizes including the absorber and solvent pumps are required. This will have an adverse impact on both the capital and operating costs.

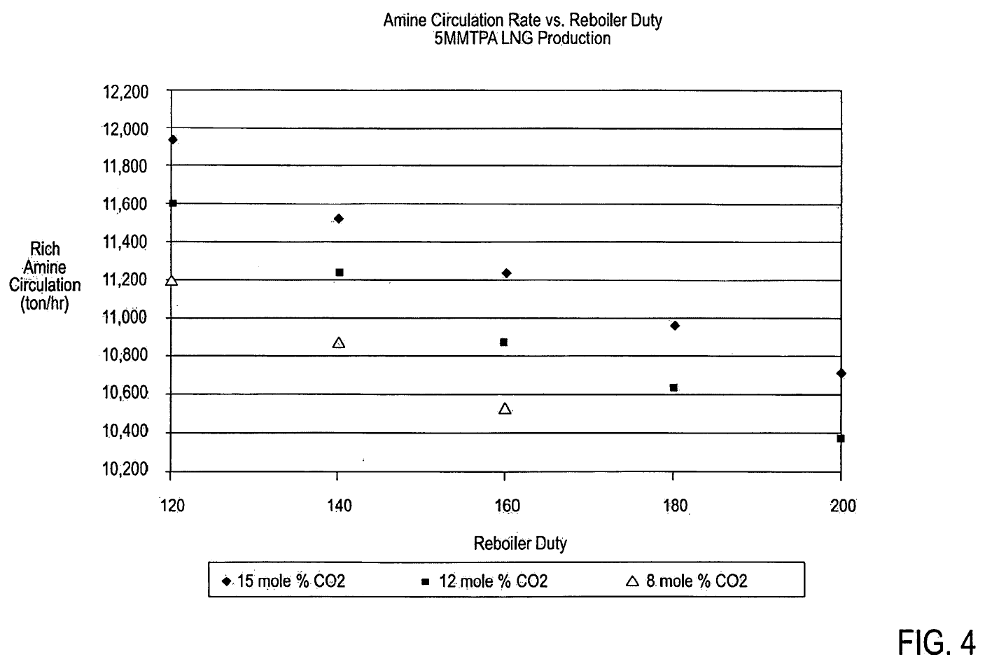

FIG. 4 shows the trade-ff between energy savings and solvent circulation rates for a two-stage process. As one would expect, the two-stage process can be designed for very low energy demand (up to 60% reduction), but that will require a quite large solvent circulation rate. It was estimated that the capital investment can increase by at least 31% of the single-stage case with the same feed conditions. However, as mentioned before, the main driver for this invention is to design a safety-based gas treating unit for FLNG.

This invention provides a safety-based gas treating system for a FLNG plant. The objective is to operate the AGRUs entirely on recovered waste heat from turbine exhaust, allowing the elimination of major fired heaters or ignition sources on a floating application.

A two-stage absorber process is beneficial for CO₂ feed concentrations higher than 7.5 mole %. For the case presented here, the amount of waste heat available for amine regeneration is only sufficient up to 7.5 mole % if only single-stage process is utilized. For concentrations higher than 7.5 mole percent, supplementary heating by fired heaters have to be incorporated. A two-stage process is able to reduce the regeneration heat demand down to the waste heat recovery limit or by as much as 60%; however, the energy saving is at the expense of a large circulation rate. This is because the majority of CO₂ removal is done by semi-lean solvent which has a higher lean CO₂ loading than a typical lean solvent found in a single-stage process. Large solvent circulation rate means larger absorber columns and solvent pumps as well. This will affect the capital investment cost by at least 31% when compared with a single-stage process.

Despite the large capital cost requirement, the two-stage process is still worth consideration because it can provide a safe gas treating system that operates only by waste heat and eliminates major fired heaters on a FLNG.

### DETAILED DESCRIPTION OF THE FIGURES

FIG. 1 is a schematic representation of apparatus 100 that includes bulk absorber 105 and lean absorber 110, which have inlets for feed gas 101, semi-lean amine solution 146, lean amine solution 104 and make up water 103. The feed gas flows up through the absorbers where the feed gas contacts the amine solutions passing down through the absorber column. Carbon dioxide and other acid gases are absorbed from the feed gas into the amine solutions to produce a rich amine solution 115 that is removed from the bottom of the absorbers. The rich amine solution is rich in carbon dioxide and other acid gases and may contain some dissolved or entrained hydrocarbons.

Rich amine solution 115 is directed from the absorbers to high pressure flash vessel 120 where the high pressure flashing causes dissolved and entrained hydrocarbons to separate from the solution and pass out of the flash vessel as an overhead vapor stream. Because this is a high pressure flash, most of the acid gases in the rich amine stream remain in the liquid phase. The overhead stream coming off flash vessel 120 can be used for a variety of purposes such as fuel gas in associated equipment and facilities.

The bottom stream coming off high pressure flash vessel 120 is directed to low pressure flash vessel 125. Flash vessel 125 receives heat in the flow of overhead vapor 153 from stripper column 150. The combination of the pressure drop and heat within the flash vessel 125 enables dissolved and entrained acid gases to separate and evolve producing semi-lean amine solution 127. The carbon dioxide content of the semi-lean amine solution will depend in part on the carbon dioxide content of the feed gas. Where the carbon dioxide content of the feed gas is about 14 mol % or more, the carbon dioxide content of the semi-lean amine solution should be less than about 5 mol %, and in some cases less than about 4 mol %. The overhead stream 126 is directed to reflux condenser 170. The acid gases 171 exiting condenser 170 can be sequestered or stored for additional handling or processing (not illustrated).

The semi-lean amine solution 127 is split into first and second portions by flow splitter 130. First portion 131 is larger than second portion 132, generally in a ratio of at least about 4:1 as described above. The first portion 131 of the semi-lean amine solution is then pumped into bulk absorber 105 for contacting with the feed gas flowing up through the absorber column. The bulk of carbon dioxide in the feed gas is removed in bulk absorber 105.

The second portion 132 is directed through heat exchanger 140 and then to stripper column 150. Reboiler 160 is heated with hot oil derived from liquefaction compressor drivers (not illustrated) and this heat is used to heat the semi-lean amine solution in stripper column 150. The carbon dioxide in this semi-lean amine solution is separated and reduced to produce a lean amine solution 161 having a carbon dioxide content of less than about 1 mol %, in some cases less than about 0.5 mol %, and in still other cases less than about 0.2 mol %. Lean amine solution 161 is then directed to the top of lean absorber 110 for contacting with the feed gas flowing up through the absorber column.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for separating acid gas from a natural gas stream, comprising the steps of:
contacting the natural gas stream with a semi-lean amine solution and a lean amine solution to produce a rich amine solution;
separating a first portion of carbon dioxide from the rich amine solution to produce the semi-lean amine solution;
heating a portion of the semi-lean amine solution to separate a second portion of carbon dioxide and produce the lean amine solution;
wherein the rich amine solution and semi-lean amine solution are heated from using recovered waste heat.

2. The method of claim 1, wherein the waste heat is recovered from one or more of a land based facility or an off-shore facility located on a platform or floating vessel.

3. The method of claim 2, wherein the waste heat is recovered from one or more of a turbine, compressor, and compressor driver.

4. The method of claim 1, wherein the first portion of carbon dioxide is separated from the rich amine solution by one or more of reducing the pressure on the rich amine solution and heating the rich amine solution.

5. The method of claim 4, wherein rich amine solution is heated by providing heat to the rich amine solution in a flash vessel from an overhead stream of a stripper column, the stripper column having a reboiler heated with the recovered waste heat.

6. The method of claim 1, wherein the semi-lean amine solution is heated in a stripper column.

7. The method of claim 6, wherein heat is provided to the stripper column through a reboiler heated with the recovered waste heat.

8. The method of claim 1, wherein the natural gas stream contains at least about 7 mol % carbon dioxide before contacting the semi-lean amine solution.

9. The method of claim 8, wherein the natural gas stream contains at least about 7.5 mol % carbon dioxide before contacting the semi-lean amine solution.

10. The method of claim 9, wherein the natural gas stream contains at least about 8 mol % carbon dioxide before contacting the semi-lean amine solution.

11. The method of claim 1, wherein the rich amine solution is flashed in a flash vessel to remove hydrocarbon vapor before separating the first portion of carbon dioxide from the rich amine solution.

12. A method for reducing emissions from an acid gas treating unit associated with a natural gas liquefaction plant, the method comprising the steps of:
contacting a natural gas stream with a semi-lean amine solution and a lean amine solution to produce a rich amine solution;
heating the rich amine solution to and produce the semi-lean amine solution;
heating a portion of the semi-lean amine solution to separate carbon dioxide and produce the lean amine solution;
wherein the rich amine solution and semi-lean amine solution are heated with recovered waste heat.

13. The method of claim 12, wherein the waste heat is recovered from one or more of a land-based facility, or an off-shore facility located on a platform or floating vessel.

14. The method of claim 12, wherein the waste heat is recovered from a heat generating unit in a liquefaction plant.

15. The method of claim 14, wherein the waste heat is recovered from one or more of a turbine, compressor, and compressor driver.

16. The method of claim 12, wherein the rich amine solution and semi-lean amine solution are heated without the use of a fired heater.

17. The method of claim 12, further comprising the step of sequestering the carbon dioxide separated from the rich amine solution and semi-lean amine solution.

18. A method for operating an acid gas treating unit associated with a natural gas liquefaction plant, the method comprising the steps of:
recovering heat from a liquefaction facility;
regenerating in an acid gas treating unit a rich amine solution by heating the rich amine solution to separate carbon dioxide and produce a semi-lean amine solution; and
contacting a natural gas stream with the semi-lean amine solution to remove carbon dioxide from the natural gas stream and produce a rich amine solution;
wherein the rich amine solution is heated with heat recovered from the liquefaction facility such that no additional carbon dioxide is emitted from the liquefaction facility and the acid gas treating unit when regenerating the rich amine solution.

19. The method of claim 18, further comprising the steps of:
heating a portion of the semi-lean amine solution with heat recovered from the liquefaction facility to separate carbon dioxide from the semi-lean solution to produce a lean amine solution; and
contacting the natural gas stream with the lean amine solution to remove carbon dioxide from the natural gas stream and produce a rich amine solution.

20. The method of claim 18, wherein the heat is recovered from a liquefaction facility located on shore or on an off-shore facility located on a platform or floating vessel.

21. The method of claim 18, wherein the heat is recovered from one or more of a turbine, compressor, and compressor driver in the liquefaction facility.

22. The method of claim 18, further comprising the step of sequestering the carbon dioxide separated from the rich amine solution.

23. An apparatus for liquefying a natural gas stream, the apparatus comprising:
a liquefaction unit having a heat generating unit; and
an acid gas treating unit connected to the liquefaction unit having:
an amine absorber for contacting a natural gas stream with a semi-lean amine solution and a lean amine solution to remove carbon dioxide from a natural gas stream and produce a rich amine stream;
a first flash vessel connected to the amine absorber for separating a first portion of carbon dioxide from the rich amine solution to produce the semi-lean amine solution; and
a stripper column connected to the flash vessel for separating a second portion of carbon dioxide from a portion of the semi-lean amine solution to produce the lean amine solution;
wherein the stripper column is connected to the heat generating unit for receiving heat therefrom.

24. The apparatus of claim 23, further comprising a second flash vessel connected intermediate the amine absorber and the first flash vessel, the second flash vessel for removing hydrocarbon vapors from the rich amine solution.

25. The apparatus of claim 23, wherein one or more of the liquefaction unit and the acid gas treating unit is located on shore, or off-shore on a platform or floating vessel.

26. The apparatus of claim 23, wherein the heat generating unit comprises one or more of turbine, compressor, and compressor driver.

27. The apparatus of claim 23, wherein the heat generating unit does not comprise a fired heater.
